(19) United States
(12) Patent Application Publication
(10) Pub. No.: US 2024/0104343 A1
(43) Pub. Date: Mar. 28, 2024

(54) Neural network system and method for predicting financial performance of an entity at a geographic location

(71) Applicant: DRB Systems, LLC, Akron, OH (US)

(72) Inventors: Christopher Aaron Barfuss, Nampa, ID (US); Chris Moriarity, Garden City, ID (US)

(73) Assignee: DRB Systems, LLC, Akron, OH (US)

(21) Appl. No.: 18/243,742

(22) Filed: Sep. 8, 2023

Related U.S. Application Data
(60) Provisional application No. 63/404,923, filed on Sep. 8, 2022.
(60) Provisional application No. 63/424,861, filed on Nov. 11, 2022.

(51) Int. Cl. G06N 3/0442; G06N 3/0985; G06Q 40/06

(52) U.S. Cl. CPC G06N 3/0442; G06N 3/0985; G06Q 40/06

(57) ABSTRACT

A process of evaluating whether to open a new car wash at a new geographic location includes establishing the geographic location for consideration, obtaining real-time data generated for a plurality of existing car washes at or near the geographic location, and categorizing the real-time data obtained for each of the existing car washes into a plurality of defined categories. A data structure linking the real-time data obtained with unique location identifiers is generated, and demographic information is accessed for the respective locations using the location identifiers. An artificial neural network generates a financial prediction indicating an expected financial performance of the car wash if constructed at the geographic location based on the data structure. A determination can be made whether to construct the new wash at the geographic location based on whether an expected financial performance of the car wash at the geographic location satisfies a minimum performance threshold.

### CROSS-REFERENCE TO RELATED APPLICATIONS

This patent application claims priority to U.S. provisional patent application 63/404,923 having a filing date of Sep. 8, 2022, and the subject matter of U.S. provisional patent application 63/404,923 is incorporated by reference into this application. This patent application also claims priority to U.S. provisional patent application 63/424,861 having a filing date of Nov. 11, 2022, and the subject matter of U.S. provisional patent application 63/424,861 is incorporated by reference into this application.

### BACKGROUND OF THE INVENTION

### 1. Field of the Invention

This application relates generally to a method and apparatus for evaluating geographic locations as candidates for opening a business entity and, more specifically, to a method and apparatus that utilize an artificial neural network with real-time data collected for a similar business entity with demographic data to estimate a return by the business entity at a specific geographic location.

### 2. Description of Related Art

Traditionally, evaluating geographic locations as candidates for constructing a new business entity focused on publicly-available information. For example, the population within a defined distance from the geographic location under consideration, or the traffic along the road where the new business entity is to be formed are afforded considerable weight during such an analysis.

However, databases of publicly-available information are not regularly maintained or updated in real time. Most of the data available through such sources can be several years old, and census data is updated once every ten years. Further, it is believed that such publicly-available data is of limited value in predicting whether a business entity will thrive at the geographic location under consideration. A variable such as the number of vehicles that pass through the geographic location over a period of time seems to be a relevant data point to consider for a car wash, for example. Conventional wisdom suggests that the greater the number of vehicles nearby, the greater number of car washes will be sold. But without context that data may not only lack much predictive value of future performance of a car wash at that geographic location, but it can be outright misleading.

### BRIEF SUMMARY OF THE INVENTION

Accordingly, there is a need in the art for a system and method for applying an artificial neural network to a data set that includes static information and real-time information collected for the specific business entity proposed to be built at a selected geographic location. The system and method can optionally predict specific financial performance metrics based on the categories of data processed by the artificial neural network and can use the data set to train the artificial neural network and drive improvements to the predictive nature of the artificial neural network.

According to one aspect, the subject application involves a non-transitory computer-readable medium storing computer-executable instructions that, when executed by at least a processor of a computing system, cause the computing system to receive, by at least the processor, a geographic location specified by a user as a potential future location of a car wash. The computing system obtains, over a communication network, real-time data generated for a plurality of existing car washes at or near the geographic location. With at least the processor, the real-time data obtained for each of the existing car washes is categorized into a plurality of defined categories, which can include at least one, a plurality, or all of:
a. member information about the existing car wash,
b. financial information about the existing car wash, and
c. traffic information about the existing car wash;

With at least the processor, a data structure is generated linking the real-time data obtained for the existing car washes with unique location identifiers that indicate respective locations where the existing car washes linked to the real-time data are located. Demographic information is requested over the communication network for the respective locations using the location identifiers. At least the processor modifies the data structure to include at least a portion of the real-time data and at least a portion of the demographic information. A neural network generates a financial prediction indicating an expected financial performance of the car wash if constructed at the potential future location based on the data structure.

According to one aspect, the subject application involves a process of opening a new car wash at a new geographic location. Some embodiments of the process include establishing the geographic location for consideration for placement of the new car wash in a computing system and, with the computing system, obtaining real-time data generated for a plurality of existing car washes at or near the geographic location over a communication network. With the computing system, the real-time data obtained for each of the existing car washes is categorized into a plurality of defined categories. Examples of the defined categories include at least one, a plurality, or all of:
a. member information about the existing car wash,
b. financial information about the existing car wash, and
c. traffic information about the existing car wash.

With the computing system, a data structure is generated and links the real-time data obtained for the existing car washes with unique location identifiers that indicate respective locations where the existing car washes linked to the real-time data are located. The computing system accesses demographic information for the respective locations using the location identifiers and modifies the data structure to include at least a portion of the real-time data and at least a portion of the demographic information. A neural network configured on the computing system generates a financial prediction indicating an expected financial performance of the car wash if constructed at the geographic location based on the data structure. A determination can be made that the expected financial performance of the car wash at the geographic location satisfies a minimum performance threshold or fails to satisfy the minimum performance threshold. Based at least in part on the determination that the expected financial performance of the car wash at the geographic location satisfies the minimum performance threshold, the car wash can be constructed at the geographic location. But based at least in part on the determination that the expected financial performance of the car wash at the geographic location fails to satisfy the minimum performance threshold, a different geographic location can be established for consideration for placement of the new car wash in the computing system.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 is a schematic representing an embodiment of an artificial neural network;

FIG. 2 is a flow diagram schematically illustrating an embodiment of a process of evaluating a geographic location as a candidate for a new car wash according to some aspects of the present disclosure; and

FIG. 3 illustrates an embodiment of a computing system configured with the artificial neural network, systems and/or processes disclosed herein.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

The present disclosure involves the use of an artificial neural network to generate a financial prediction indicating an expected financial performance of a car wash, assuming that car wash is constructed at a potential future location. By controlling the inputs to the artificial neural network and the data included in a training set used to tune or train the artificial neural network, the financial prediction can optionally be limited to certain key performance indicators (“KPIs”) of interest. For example, real-time industry data such as financial information, traffic information and member information collected or generated by or on behalf of existing car washes within (or within a defined proximity to) a selected geographic location can be aggregated into a data set.

Although the present disclosure discusses a process and system for predicting a financial performance of a car wash if opened at a new geographic location, the scope of the present disclosure is not so limited. Instead, the financial performance can be predicted for any retail or other business entity at a geographic location, or within a defined proximity of a geographic location. For example, other embodiments of the business entity can include a convenience store, or a mobile convenience store. Convenience stores are retail businesses with primary emphasis placed on providing the public a convenient location to quickly purchase from a wide array of consumable products (predominantly food or food and gasoline) and/or services. Similarly, a mobile convenience store can offer retail services for the types of goods sold by brick-and-mortar convenience stores, but a relatively limited selection and on a relatively-smaller scale.

According to such embodiments, the real time information and/or demographic information discussed below can include one or more categories of data specific to convenience stores. Some of the information discussed below for car washes can also factor into predicting the financial performance of a convenience store at the geographic location under consideration. However, other information such as food retail information, the presence of nearby grocery stores, etc. may be relevant to convenience stores, but have limited relevance for car washes. And for mobile convenience stores or other retail entities, for example, the geographic can include more than a single, fixed location. The geographic location under consideration can encompass a portion, but less than all of a city, or an entire city. According to alternate embodiments, the geographic location can optionally include a plurality of streets covered by the mobile convenience store.

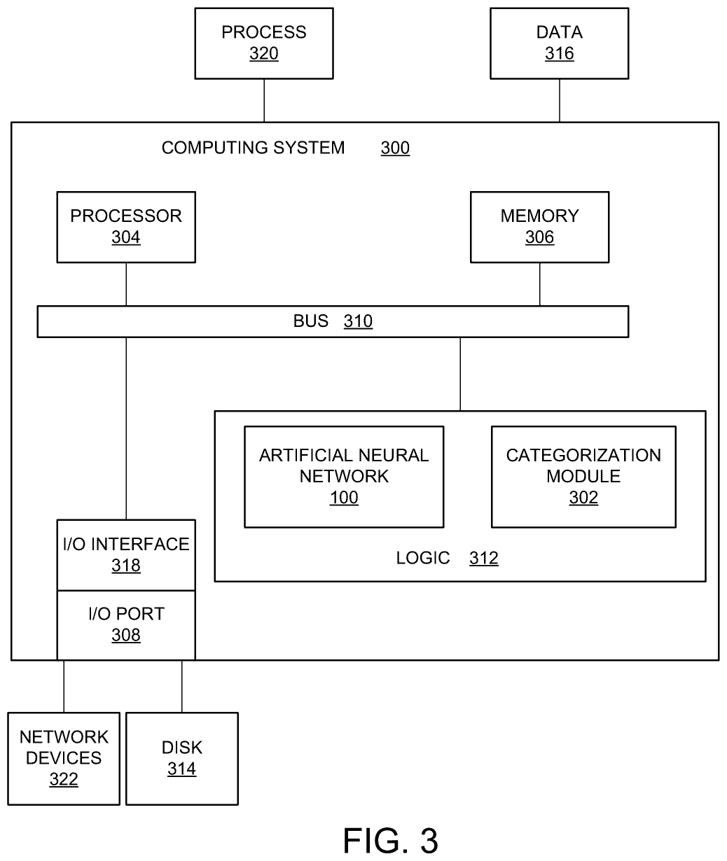

“Real time” data is data that is created and collected on an ongoing basis, optionally at a time when the data is to be used as described herein. As an example, consider data generated by existing car washes located within fifty (50 mi.) miles of an intersection under consideration for a new car wash. Financial information such as revenue realized (annual, monthly, etc.) from car wash/detailing services, retail sales, membership fees, etc. can be collected through point-of-sale terminals, car wash kiosks, online portals, etc. Similarly, traffic information such as retail and member traffic and traffic percentages and total traffic numbers for example, and member information such as member counts and average length of membership can be collected through traffic sensors and/or counters that track usage of car wash bays, or a database storing membership information for example. This data is collected as it is generated (i.e., in real time), and aggregated until a time when it is to be transmitted over a communication network such as the Internet, for example. The transmitted data can be received by a computing system 300 configured with an artificial neural network such as that described with reference to FIG. 3 to generate the financial prediction as described herein.

A specific embodiment of a real-time data set is provided in Table 1, below. Each variable in the data set is associated with a unique location ID representing the physical location of the geographic location that generated and/or collected the data corresponding to the variables in the data set.

TABLE 1

| Variable | Purpose |
|---|---|
| PLID | Location ID |
| ARMMEM | Member Count |
| YEARREV | Yearly Revenue |
| MRTREV | Monthly Retail Revenue |
| RTREVP | Retail Revenue Percentage |
| MMEMREV | Member Revenue |
| MEMREVP | Member Revenue Percentage |
| TTLREV | Total Monthly Revenue |
| RTTRAFF | Retail Traffic |
| RETTRAFFP | Retail Traffic Percentage |
| MEMTRAFF | Member Traffic |
| MEMTRAFFP | Member Traffic Percentage |
| TTLTRAFF | Total Traffic |
| RTTCK | Retail Ticket Average |
| RCHTCK | Recharge Ticket Average |
| RPC | Revenue Per Car |
| TENURE | Average Length of Membership |

One technical problem that has prevented the widespread use of real-time data with computer systems configured with artificial neural networks is that the data input into artificial neural networks must be properly categorized. Improperly categorized data can bias the training of artificial neural networks toward a false target. As a result, location analysis tools use publicly-available data (e.g., census, consumer research) alone to score the potential of the location in question.

In an effort to overcome this obstacle, the present technology includes a categorization module 302 provided to the computing system 300 that categorizes real-time data into a data set that can be used for training the artificial neural network and/or generate the financial prediction. A data set with KPIs for unique locations can be built, as represented by “X” in equation (1), and then joined with specific demographic features as described herein (xᵢ in equation (1)). This data set allows for the forecast of specific values only limited to KPI's in the training set. In other words, if annual revenue is included in the training data set, annual revenue can be forecasted by the artificial neural network trained with such a training set.

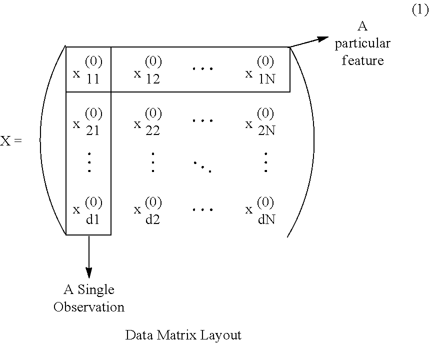

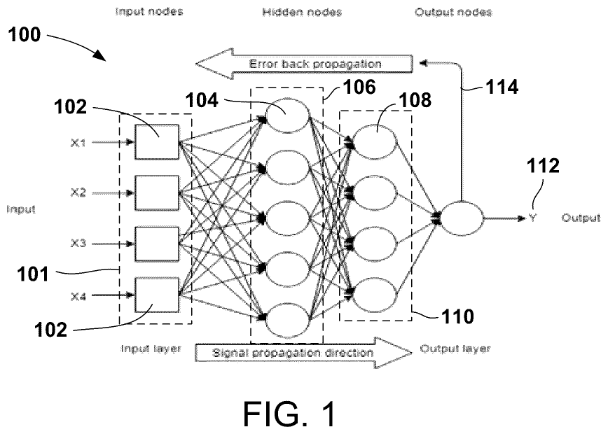

An artificial neural network is a statistical model that processes nonlinear relationships between inputs and outputs in parallel. Useful artificial neural networks include both Long Short-Term Memory (LSTM) and Gated Recurrent Units (GRU) neural networks. A schematic representing an embodiment of an artificial neural network 100 is shown in FIG. 1. For the illustrated embodiment, the artificial neural network 100 includes an input layer 101 comprising a plurality of input nodes 102 to which the KPIs of interest are introduced. Each input node 102 propagate its respective input to each of a plurality of first layer nodes 104 forming a first hidden layer 106. The first layer nodes 104 are configured to calculate one or more outputs using a nonlinear function of the sum of its inputs. The first layer nodes 104 can optionally transmit their respective outputs regardless of the value of the outputs, or can optionally transmit only outputs if the aggregate of the outputs exceed a threshold value. But the first layer nodes 104 that do transmit an output, transmit that output to each of a plurality of second layer nodes 108 forming a second hidden layer 110 or to an output layer 112 comprising a single output node 114 that generates a single output (“Y” in FIG. 1), which is the financial prediction of interest in the present example. The calculated error 114 can optionally be fed back toward the input layer to further train the artificial neural network 100.

Tuning, or training, the artificial neural network 100 involves introducing training data sets that have a known outputs 112 to the input layer 101. The non-linear functions are executed on the data by the nodes 104, 108 at each hidden node layer 106, 110 to learn the optimal solution that produces the least, or at least a minimal acceptable error. Tunable parameters of the artificial neural network 100 are determined to achieve the desired error. The tunable parameters that can be determined include, but are not limited to weights assigned to each node, the learning rate, the number of nodes to be utilized, the dropout, number of epochs, the batch size, and the validation split for example.

Specific examples of the tunable parameters, also referred to as “hyper parameters,” that can be adjusted based on processing of a training data set to minimize an expected error of the financial prediction include:
a. the number of nodes used to process the data structure.
b. a learning rate, which establishes the “step-size” the artificial neural network 100 uses to update the weights, directly affects the performance and accuracy of the model.
c. a first and/or second dropout value, which interfere with “over-fitting” the model by randomly turning on and off certain nodes. For illustrative purposes, consider a study of how a mouse learns to navigate a maze. To ensure that the mouse isn't simply learning how to navigate one specific maze, a researcher may move certain walls or openings to ensure the mouse isn't just memorizing that maze. The movement of walls and/or openings is analogous to the effect created by the dropout value, which adds/moves/removes nodes by turning some on and off.
d. a number of epochs, which determines how many times the entire data set will pass through each node. After each pass, the loss is calculated, and the weights are updated. Too few epochs, and the model will be inaccurate, but too many epochs will over-fit the model, and be of little value.
e. a batch size, representing the total number of samples from the data set(s) to be used during training of the model.
f. a validation split, which can be utilized to test the model's accuracy. The data is split into a testing, and training groups. The training set is generally the majority of the data, and can be used to set up the model. The smaller testing set can be used to check the accuracy of the model. For example, if there are 100 geographic locations in a data set, 80 of those geographic locations could be used to build the model, and the prepared model could be used to make predictions for the remaining 20 geographic locations. As the testing data contains the actual outcomes, you can measure the model's accuracy.

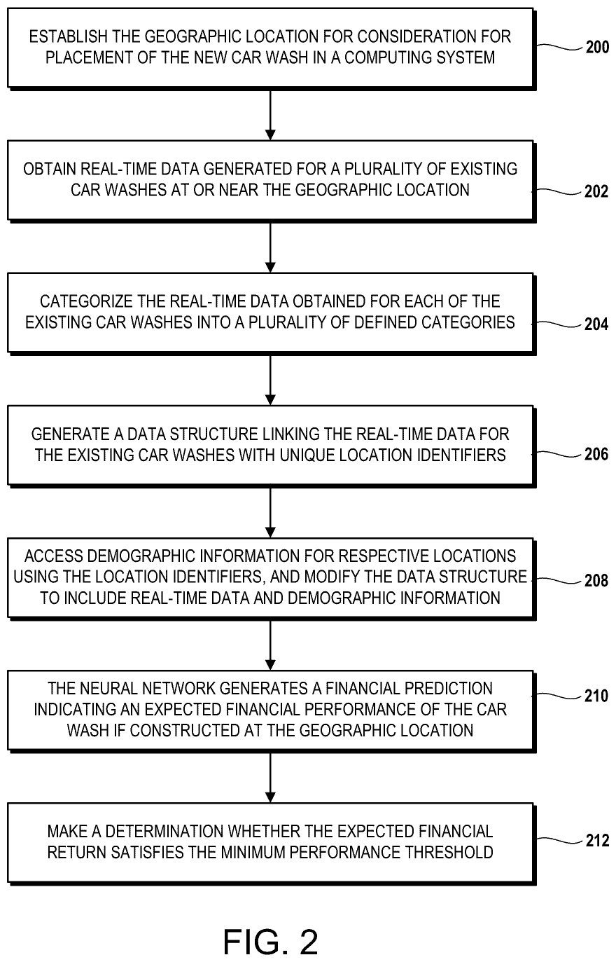

With the artificial neural network 100 trained, the computing system 300 can be utilized to generate a financial prediction that indicates the expected financial performance of a car wash proposed to be constructed at a proposed geographic location. FIG. 2 is a flow diagram schematically illustrating an embodiment of a process of performing such an evaluation, and includes establishing the geographic location being considered for placement of the new car wash in a computing system at block 200. For example, a user can enter an address, GPS coordinates, a road name, an intersection, a zip code, etc. into a user interface displayed by a display device operatively connected to the computing system 300.

At block 202, the computing system 300 can obtain real-time data generated for a plurality of existing car washes at or near the geographic location over a communication network. For example, the computing system 300 can be configured to request transmission of such data for existing car washes within X miles of the geographic location. The request can be made, and the real-time data optionally received through operation of an API or other data communication platform that establishes a communication channel between the computing system 300 and a remote data platform that aggregates the real-time data for a plurality of the existing car washes. Real-time data may be most readily available from existing car washes that are franchise locations (e.g., affiliated with a common parent entity) that will be affiliated with the car wash to be constructed at the potential future location, if deemed to be financially prudent.

The distance X can be any desired value that will return real-time data from one or a plurality of existing car washes, and optionally exclude remote car washes that are located far outside the geographic area since those remote car washes can generate “outlier” real-time data. Outlier real-time data can be misleading for the geographic location under consideration. For example, car washes with many bays in a large metropolitan area are likely to generate considerably more revenue than a single bay car wash located in a rural community. Including the real-time data from one such location in an evaluation of the potential to generate revenue in the other location is likely to introduce considerable error. The value of X can be any desired mileage such as five (5 mi.) miles, ten (10 mi.) miles, twenty-five (25 mi.) miles, fifty (50 mi.) miles, etc.

The categorization module 302 of the computing system 300 can categorize all site-specific key performance indicators, demographic data, psychographic data, mobile GPS origin data, and future area growth projections and the real-time data obtained for each of the existing car washes into a plurality of defined categories at block 204. As noted above, the technical problems associated with using data such as the real-time data in evaluation possible locations for constructing a business entity are caused, at least in part, by the raw nature of incoming real-time data. For example, the real-time data may be received by the computing system 300 in a different order or format for each of a plurality of car washes. To address such an obstacle, the categorization module 302 can organize the real-time data into a standardized data structure, configured for use with the artificial neural network 100 as described herein. When the data structure is introduced as input to the artificial neural network 100 the stored data can be processed in accordance with the configuration of the artificial neural network 100 to produce an accurate output 112.

The real-time data collected for each existing car wash can optionally be categorized as: member information about the existing car wash, financial information about the existing car wash, or traffic information about the existing car wash. For example, the member information can include information about paying members who have subscribed to one or more service plans at the existing car wash. The member information can include at least one of: a number of members of the existing car wash, and an average length of membership for the members.

According to some embodiments, the financial information can include at least one of:
a. annual revenue—revenue generated by the car wash in the most-recent twelve (12) month period, or revenue generated year to date, etc.
b. monthly retail revenue—revenue generated through sales of goods other than car wash services at the existing car wash.
c. retail revenue percentage —revenue percentage specifically driven by non-member or subscription patrons.
d. member revenue—revenue generated through the sale of subscriptions for car wash services or all revenue derived from active members of the existing car wash.
e. member revenue percentage—revenue percentage specifically driven by member or subscription patrons.
f. total monthly revenue—total revenue generated by the existing car wash for each of the last twelve (12) months, or other suitable period of time, or average revenue generated by all sources at the existing car wash over the last twelve (12) months or other suitable period of time.
g. retail ticket average—the average dollar amount of retail sales at the existing car wash.
h. recharge ticket average—the collective revenue per car average across all retail wash options.
i. revenue per car—the average revenue generated per car, per visit to the existing car wash.

According to some embodiments, the real-time data to be categorized as the traffic information can include at least one of:
a. retail traffic—the number of vehicles, patrons, etc. associated with retail sales at the existing car wash.
b. retail traffic percentage—the percentage of non-member, or non-subscription cars patronizing the location.
c. member traffic—the number of active members and/or member vehicles that visit the existing car wash over a defined period of time.
d. member traffic percentage—the percentage of member, or subscription cars patronizing the location.
e. total traffic—the total count all traffic through the location including non-revenue events such as free washes and rewashed.

The computing system 300 generates a data structure linking the real-time data obtained for the existing car washes with unique location identifiers at block 206. The unique location identifiers can be any marker such as numbers, letters, both numbers and letters that indicate respective locations where the existing car washes linked to the real-time data are located. Regardless of their format, the unique location identifier is used to access demographic information about the geographic locations of the existing car washes, and the data structure is modified at block 208 to include a combination of the real-time data and the demographic data.

According to some embodiments, the demographic information included in the data structure can optionally be limited to the specific entries that are believed to be factors that could affect the financial performance of a car wash at the proposed location under consideration. For example, the initial data-pull may contain over 800 unique variables and characteristics of the geographic location under consideration. To determine which variables will remain, the data can be put through a Lasso-Regression, which attaches weights to each statistically-meaningful element, and reduces all non-meaningful elements to zero, effectively removing the elements with a weight of zero from the data structure.

At block 210, the data structure is input to the artificial neural network 100 configured on the computing system 300, to generate a financial prediction indicating an expected financial performance of the car wash if constructed at the geographic location. As noted above, the measure of the financial prediction can be any KPI that was included in the training data sets used to train the artificial neural network 100. The expected financial performance can be compared to a minimum performance threshold at block 212 to make a determination whether the expected financial return satisfies the minimum performance threshold. The user can then use the output 112 of the artificial neural network 100 to construct a car wash at the geographic location under consideration. If the geographic location satisfies the minimum performance threshold, the user can optionally decide to construct the car wash at the geographic location, or continue to investigate by considering other factors. On the other hand, the user can optionally establish a different geographic location for consideration for the new car wash in the computing system 300, and repeat the process described above.

To limit the sense of confidence conveyed to the user, the computing system 300 can optionally limit the expected financial performance to a value that is less than the top performing car washes associated with real-time data factored into the evaluation described herein. For example, the computing system 300 can optionally cap the expected financial performance generated as the output 112 at a value that would exceed a realized financial performance of no more than ninety-five (95%) percent, or any other portion of the existing car washes.

FIG. 3 illustrates an embodiment of the computing system 300 configured with the artificial neural network 100, the categorization module 302 systems and/or processes disclosed herein. The exemplary computing system 300 may be a computer that includes a processor 304, a memory 306, and input/output ports 308 operably connected by a bus 310. In one example, the computing system 300 may include logic 312 configured to control operation of a display. In different examples, the logic 312 may be implemented in hardware, a non-transitory computer-readable medium with stored instructions, firmware, and/or combinations thereof. While the logic 312 is illustrated as a hardware component attached to the bus 310, it is to be appreciated that in other embodiments, the logic 312 could be implemented in the processor 304, stored in memory 306, or stored in disk 314.

In one embodiment, logic 312 or the computing system 300 is a means (e.g., structure: hardware, non-transitory computer-readable medium, firmware) for performing the actions described. In some embodiments, the computing system 300 may be a server operating in a cloud computing system, a server configured in a Software as a Service (SaaS) architecture, a smartphone, laptop, tablet computing device, and so on.

The means may be implemented, for example, as an ASIC programmed to perform the processes described herein. The means may also be implemented as stored computer executable instructions that are presented to computing system 300 as data 316 that are temporarily stored in memory 306 and then executed by processor 304.

Logic 312 may also provide means (e.g., hardware, non-transitory computer-readable medium that stores executable instructions, firmware) for performing the operations regarding the processes described herein.

Generally describing an illustrative configuration of the computing system 300, the processor 304 may be a variety of various processors including dual microprocessor and other multi-processor architectures. A memory 306 may include volatile memory and/or non-volatile memory. Non-volatile memory may include, for example, ROM, PROM, and so on. Volatile memory may include, for example, RAM, SRAM, DRAM, and so on.

A storage disk 314 may be operably connected to the computing system 300 via, for example, an input/output (I/O) interface (e.g., card, device) 318 and an input/output port 308. The disk 314 may be, for example, a magnetic disk drive, a solid-state disk drive, a floppy disk drive, a tape drive, a Zip drive, a flash memory card, a memory stick, and so on. Furthermore, the disk 314 may be a CD-ROM drive, a CD-R drive, a CD-RW drive, a DVD-ROM, and so on. The memory 306 can store a process 320 and/or a data 316, for example. The disk 314 and/or the memory 306 can store an operating system that controls and allocates resources of the computing system 300.

The computing system 300 may interact with input/output (I/O) devices via the I/O interfaces 318 and the input/output ports 308. Input/output devices may be, for example, a keyboard, a microphone, a pointing and selection device, cameras, video cards, displays, the disk 314, the network devices 322, and so on. The input/output ports 308 may include, for example, serial ports, parallel ports, and USB ports.

The computing system 300 can operate in a network environment and thus may be connected to the network devices 322 via the I/O interfaces 318, and/or the I/O ports 308. Through the network devices 322, the computing system 300 may interact with a network. Through the network, the computing system 300 may be logically connected to remote computers. Networks with which the computing system 300 may interact include, but are not limited to, a LAN, a WAN, and other networks.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following section's content includes definitions of selected terms employed herein. These definitions include various examples and/or forms of components that fall within the scope of a term and that may be used for implementation. These examples are not intended to be limiting. Both singular and plural forms of terms may be included within these definitions.

References to “one embodiment,” “an embodiment,” “one example,” “an example,” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure,” as used herein, is an organization of data in a computing system that is stored in a memory medium, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium,” as used herein, refers to a non-transitory medium that stores instructions and/or data configured to perform one or more of the disclosed functions when executed by at least a single processor. Data may function as instructions in some embodiments. A computer-readable medium may take forms, including, but not limited to, non-volatile media or volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read-only memory (ROM), a memory chip or card, a memory stick, solid-state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic,” as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a goal, then hardware would be selected to implement functions. If a lower cost is desired, then stored instructions/executable application would be selected to implement the functions.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A non-transitory computer-readable medium storing computer-executable instructions that, when executed by at least a processor of a computing system, cause the computing system to:
receive, by at least the processor, a geographic location specified by a user as a potential future location of a car wash;
obtain, over a communication network, real-time data generated for a plurality of existing car washes at or near the geographic location;
categorize, with at least the processor, the real-time data obtained for each of the existing car washes into a plurality of defined categories, the defined categories comprising at least:
a. member information about the existing car wash,
b. financial information about the existing car wash, and
c. traffic information about the existing car wash;
generate, with at least the processor, a data structure linking the real-time data obtained for the existing car washes with unique location identifiers that indicate respective locations where the existing car washes linked to the real-time data are located;
request, over the communication network, demographic information for the respective locations using the location identifiers;
modify, with at least the processor, the data structure to include at least a portion of the real-time data and at least a portion of the demographic information; and
with a neural network, generate a financial prediction indicating an expected financial performance of the car wash if constructed at the potential future location based on the data structure.

2. The non-transitory computer-readable medium of claim 1, wherein the real-time data is obtained through operation of an API that establishes a communication channel between the computing system and a remote data platform that aggregates the real-time data for a plurality of the existing car washes.

3. The non-transitory computer-readable medium of claim 2, wherein the existing car washes comprise franchise locations that are to be affiliated with the car wash to be constructed at the potential future location.

4. The non-transitory computer-readable medium of claim 1, wherein the real-time data to be categorized as the member information comprises at least one of:
a. a number of members of the existing car wash, and
b. an average length of membership for the members.

5. The non-transitory computer-readable medium of claim 1, wherein the real-time data to be categorized as the financial information comprises at least one of:
a. annual revenue,
b. monthly retail revenue,
c. retail revenue percentage,
d. member revenue,
e. member revenue percentage,
f. total monthly revenue,
g. retail ticket average,
h. recharge ticket average, and
i. revenue per car.

6. The non-transitory computer-readable medium of claim 1, wherein the real-time data to be categorized as the traffic information comprises at least one of:
a. retail traffic,
b. retail traffic percentage,
c. member traffic,
d. member traffic percentage, and
e. total traffic.

7. The non-transitory computer-readable medium of claim 1, wherein the demographic information comprises population information about residents who reside within a defined distance from the potential future location.

8. The non-transitory computer-readable medium of claim 1 further comprising computer-executable instructions that, when executed by at least the processor of the computing system, cause the computing system to:
limit the expected financial performance to a value that would exceed a realized financial performance of no more than ninety five (95%) percent of the existing car washes.

9. The non-transitory computer-readable medium of claim 1, wherein the neural network comprises hyper parameters that are adjusted based on processing of a training data set to minimize an expected error of the financial prediction, the hyper parameters comprising a plurality of:
a. a number of nodes used to process the data structure,
b. a learning rate,
c. a first dropout value,
d. a second dropout value,
e. a number of epochs,
f. a batch size, and
g. a validation split.

10. A process of opening a new car wash at a new geographic location, the process comprising:
establishing the geographic location for consideration for placement of the new car wash in a computing system;
with the computing system, obtaining real-time data generated for a plurality of existing car washes at or near the geographic location over a communication network;
with the computing system, categorizing the real-time data obtained for each of the existing car washes into a plurality of defined categories, the defined categories comprising at least:
a. member information about the existing car wash,
b. financial information about the existing car wash, and
c. traffic information about the existing car wash;
with the computing system, generating a data structure linking the real-time data obtained for the existing car washes with unique location identifiers that indicate respective locations where the existing car washes linked to the real-time data are located;
with the computing system, accessing demographic information for the respective locations using the location identifiers, and modifying the data structure to include at least a portion of the real-time data and at least a portion of the demographic information;
generating, with a neural network configured on the computing system, a financial prediction indicating an expected financial performance of the car wash if constructed at the geographic location based on the data structure;
making a determination that the expected financial performance of the car wash at the geographic location satisfies a minimum performance threshold or fails to satisfy the minimum performance threshold;
based at least in part on the determination that the expected financial performance of the car wash at the geographic location satisfies the minimum performance threshold, constructing the car wash at the geographic location; and
based at least in part on the determination that the expected financial performance of the car wash at the geographic location fails to satisfy the minimum performance threshold, establishing a different geographic location for consideration for placement of the new car wash in the computing system.

11. The process of claim 10, wherein the real-time data is obtained through operation of an API that establishes a communication channel between the computing system and a remote data platform that aggregates the real-time data for a plurality of the existing car washes.

12. The process of claim 11, wherein the existing car washes comprise franchise locations that are to be affiliated with the car wash to be constructed at the potential future location.

13. The process of claim 10, wherein the demographic information comprises population information about residents who reside within a defined distance from the potential future location.

14. The process of claim 10 further comprising:
limiting the expected financial performance to a value that would exceed a realized financial performance of no more than ninety five (95%) percent of the existing car washes.

15. The process of claim 1, wherein the neural network comprises hyper parameters that are adjusted based on processing of a training data set to minimize an expected error of the financial prediction, the hyper parameters comprising a plurality of:
a. a number of nodes used to process the data structure,
b. a learning rate,
c. a first dropout value,
d. a second dropout value,
e. a number of epochs,
f. a batch size, and
g. a validation split.

16. A process of opening a retail business entity at a new geographic location, the process comprising:
establishing the geographic location for consideration for placement of the retail business entity in a computing system;
with the computing system, obtaining real-time data generated for a plurality of existing retail business entities at or near the geographic location over a communication network;
with the computing system, categorizing the real-time data obtained for each of the existing retail business entities into a plurality of defined categories;
with the computing system, generating a data structure linking the real-time data obtained for the existing retail business entities with unique location identifiers that indicate respective locations where the existing retail business entities linked to the real-time data are located;
with the computing system, accessing demographic information for the respective locations using the location identifiers, and modifying the data structure to include at least a portion of the real-time data and at least a portion of the demographic information;
generating, with a neural network configured on the computing system, a financial prediction indicating an expected financial performance of the retail business entity if constructed at the geographic location based on the data structure;
making a determination that the expected financial performance of the retail business entity at the geographic location satisfies a minimum performance threshold or fails to satisfy the minimum performance threshold;
based at least in part on the determination that the expected financial performance of the retail business entity at the geographic location satisfies the minimum performance threshold, constructing the retail business entity at the geographic location; and
based at least in part on the determination that the expected financial performance of the retail business entity at the geographic location fails to satisfy the minimum performance threshold, establishing a different geographic location for consideration for placement of the retail business entity in the computing system.

17. The process of claim 16, wherein the retail business entity comprises at least one of a convenience store and a mobile convenience store.
